(19) United States
(12) Patent Application Publication
(10) Pub. No.: US 2026/0092235 A1
(43) Pub. Date: Apr. 2, 2026

(54) MULTIFUNCTIONAL MULTI-LAYER CANDLE

(71) Applicant: Liwei Huang, Shenzhen (CN)

(72) Inventor: Liwei Huang, Shenzhen (CN)

(21) Appl. No.: 18/963,536

(22) Filed: Nov. 28, 2024

(30) Foreign Application Priority Data
Sep. 27, 2024 (CN) 202422365486.0

(51) Int. Cl. C11C 5/00; F21S 13/12

(52) U.S. Cl. CPC C11C 5/008; C11C 5/002; F21S 13/12

(57) ABSTRACT

A multifunctional multi-layer candle includes a main body made of combustible material, a wick and a plurality of sleeve components removably sleeved on the main body. An upper end of the wick protrudes out from a top of the main body, and the rest part of the wick is embedded in the main body. The plurality of sleeve components can be sleeved on the main body in different sequences to form different shapes. The multifunctional multi-layer candle may be used as a children's splicing toy, a decorative ornament and a lighting. The sleeve components may be sleeved on the main body to form different candle shapes, which is beneficial for intellectual development, and the entire candle is more ornamental and funnier.

### CROSS-REFERENCE TO RELATED APPLICATION

The present application claims priority of China Patent Application No. 202422365486.0, filed on Sep. 27, 2024, the contents of which are incorporated herein by reference.

### BACKGROUND OF THE INVENTION

### 1. Technical Field

The present application relates to the technical field of candle, in particular to a multifunctional multi-layer candle.

### 2. Description of Related Art

A candle in the prior art generally includes a cylindrical main body and a wick located at a center of the main body. Arrangement of the wick and the main body enables melting and burning of the candle for a long time. However, the candles in the prior art are used only for illumination or decoration, and have single shapes and functions.

### SUMMARY OF THE INVENTION

An objective of the present disclosure is to provide a multifunctional multi-layer candle with changeable shapes.

The multifunctional multi-layer candle includes a main body made of a combustible material, a wick, and a plurality of sleeve components removably sleeved on the main body. An upper end of the wick protrudes out from a top of the main body, and the rest part of the wick is embedded in the main body. The plurality of sleeve components can be sleeved on the main body in different sequences to form different shapes.

As an implementation, each of the plurality of sleeve components includes a flat upper surface and a flat lower surface parallel with the flat upper surface, and a through hole running through the flat upper surface and the flat lower surface is defined in each of the plurality of sleeve components.

As an implementation, the main body is substantially a straight cylinder or a straight prism, and a shape and size of the through hole match those of the main body.

As an implementation, at least a part of the plurality of sleeve components have different colors.

As an implementation, each sleeve component comprises at least a flavourer or perfume or essential oil.

As an implementation, at least a part of the plurality of sleeve components have different shapes.

As an implementation, all the sleeve components are made of combustible materials. When the main body is burning, at least a part of the one, close to a candle flame, of the plurality of sleeve components will melt, gasify, and participates in the burning.

Compared with the prior art, the multifunctional multi-layer candle has at least the following four advantages.
1. The multifunctional multi-layer candle increases fun of use and can be used as a children's splicing toy, and the sleeve components of different shapes can be sleeved on the main body to form different candle shapes, which is beneficial for intellectual development.
2. The sleeve components of different colors, fragrances and shapes can be sleeved on the main body to display diverse colors and shapes, such that the entire candle is more ornamental and funnier, and may be used as a decorative ornament.
3. The sleeve components capable of releasing different fragrances also serve as decorative pieces when they are not burning. The essences inside the sleeve components naturally volatilize and release fragrances. Therefore, the present disclosure can replace rattan aroma diffusers on the market, and has functions of refreshing air, relaxing people, relieving fatigue, aiding sleep and the like.
4. When different sleeve components of the candle are burning, different fragrances are released. The present disclosure has functions of refreshing air and lighting, and is equivalent to an atomizing aroma diffuser available on the market.

### BRIEF DESCRIPTION OF THE SEVERAL VIEWS OF THE DRAWINGS

The foregoing and other exemplary purposes, aspects and advantages of the present invention will be better understood in principle from the following detailed description of one or more exemplary embodiments of the invention with reference to the drawings, in which:

FIG. 1 is an exploded view of a multifunctional multi-layer candle in accordance with an embodiment of the present disclosure.

FIG. 2 is a perspective view of the multifunctional multi-layer candle with multiple sleeve components in a first splicing state, in accordance with an embodiment of the present disclosure.

FIG. 3 is another perspective view of the multifunctional multi-layer candle with multiple sleeve components in a second splicing state, in accordance with an embodiment of the present disclosure.

### DETAILED DESCRIPTION OF THE INVENTION

The invention will now be described in detail through several embodiments with reference to the accompanying drawings.

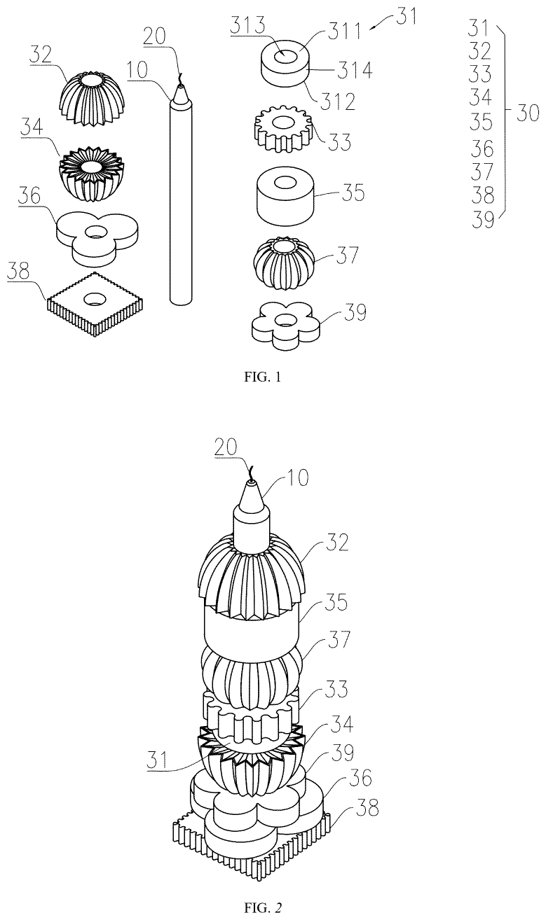

As shown in FIG. 1, in this embodiment, a multifunctional multi-layer candle including a main body 10, a wick 20 and several sleeve components 30 (9 in FIG. 1 to FIG. 3, from 31 to 39) are provided. The main body 10 is made of a combustible material such as paraffin wax, beeswax or the like. The wick 20 may be made of cotton, wood, sisal, jute, flax, hemp, etc. An upper end of the wick 20 protrudes out from a top of the main body 10, and the rest part of the wick 20 is embedded in the main body. The sleeve components 30 are removably sleeved on the main body 10, and can be sleeved on the main body 10 in different sequences to form different shapes.

All the several sleeve components 30 have a similar structure, and the structure will be described below taking sleeve component 31 as an example. The sleeve component 31 includes a flat upper surface 311, a flat lower surface 312 parallel with the flat upper surface, and a side surface 314 connecting the flat upper surface 311 and the flat lower surface 312, and a through hole 313 running through the flat upper surface 311 and the flat lower surface 312 is defined in the sleeve component 31. The side surface 314 may include one or more of the following: a curved surface, a cylindrical surface, a wavy surface, and a plane surface. That is, each sleeving component may have its unique shape.

The main body 10 is substantially a straight cylinder, and a shape and size of the through hole 313 match those of the main body 10. Understandably, in other embodiments, the main body may be substantially a straight prism, such as a cuboid, a straight pentagonal prism, etc. The wick 20 is located at a center of the main body 10, and the wick 20 is arranged along an axis of the main body 10. The through hole 313 is formed at a center of each of the sleeve components 30, and the sleeve components 30 can be sequentially sleeved on the main body 10 through the through holes to form a specific shape of the candle by a way of splicing them together.

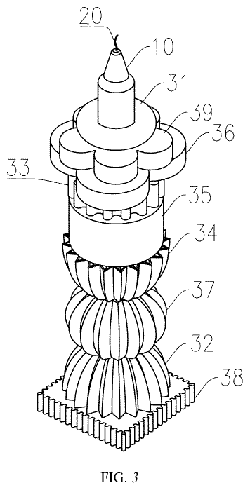

At least a part of the sleeve components 30 may have different colors, and each sleeve component 30 may include at least a flavourer or perfume or essential oil, such that can five off fragrance. In the embodiment, each sleeving component 31, 32, 33, 34, 35, 36, 37, 38, 39 has its unique shape, color and fragrance/scent. When splicing, a user can sequentially sleeve the sleeve components 30 on the main body 10 according to his/her personal preferences. FIGS. 2 and 3 illustrate two different shapes formed after splicing.

The main body 10 can be shaped like a prism or an oval cylinder, and the corresponding through holes of the sleeve components match a cross section of the main body 10 in shapes.

Even when the entire multifunctional multi-layer candle is not burning, the sleeve components containing essences beneficial to health naturally release different fragrances. The essences inside the sleeve components also serving as decorative pieces naturally volatilize and release fragrances. Therefore, the present disclosure can replace rattan aroma diffusers on the market, and has functions of refreshing air, relaxing people, relieving fatigue, aiding sleep and the like.

The user can adjust positions of the sleeve components 30 on the main body 10 according to his/her preferences, to form a desired shape. During burning of the candle, the main body 10 melts and burns with burning of the wick 20. When the melting approaches a position, a corresponding sleeving component 30 melts and burns, releasing its fragrance. When different sleeve components burn, different fragrances will be released. When the fragrance naturally released from the candle fades, the candle can be lit, and the sleeve components will release fragrances in a melting and burning process, which is more suitable for candlelight dinner scenes and the like.

It can be seen that the multifunctional multi-layer candle designed in this embodiment not only has a high splicing entertainment and ornamental value, but also is capable of releasing fragrances that people like or benefit health, refreshing air, relaxing people, relieving fatigue, aiding sleep, and enhancing comfort.

Moreover, shapes of the sleeve components 30 include common geometric shapes, petal shapes, or other shapes of objects, animals and the like. The sleeve components of the candle can be spliced to form a festive shape of Santa Claus, and the corresponding sleeve components representing different parts of Santa Claus have their own shapes. Optionally, the candle can be shaped like fruits, animals or fishes to suit different scenarios and personal preferences.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A multifunctional multi-layer candle, comprising:
a main body made of combustible material;
a wick, an upper end of which protruding out from a top of the main body, and the rest part thereof being embedded in the main body; and
a plurality of sleeve components removably sleeved on the main body;
wherein the plurality of sleeve components can be sleeved on the main body in different sequences to form different shapes.

2. The multifunctional multi-layer candle according to claim 1, wherein each of the plurality of sleeve components comprises a flat upper surface and a flat lower surface parallel with the flat upper surface, and a through hole running through the flat upper surface and the flat lower surface is defined in each of the plurality of sleeve components.

3. The multifunctional multi-layer candle according to claim 2, wherein the main body is substantially a straight cylinder or a straight prism, and a shape and size of the through hole match those of the main body.

4. The multifunctional multi-layer candle according to claim 2, wherein at least a part of the plurality of sleeve components have different colors.

5. The multifunctional multi-layer candle according to claim 2, wherein each sleeve component comprises at least a flavourer or perfume or essential oil.

6. The multifunctional multi-layer candle according to claim 2, wherein at least a part of the plurality of sleeve components have different shapes.

7. The multifunctional multi-layer candle according to claim 1, wherein all the sleeve components are made of combustible materials, when the main body is burning, at least a part of the one, close to a candle flame, of the plurality of sleeve components will melt, gasify, and participates in the burning.
